(19) United States
(12) Patent Application Publication
(10) Pub. No.: US 2026/0138192 A1
(43) Pub. Date: May 21, 2026

(54) CUBIC BORON NITRIDE SINTERED BODY AND CUTTING TOOL

(71) Applicant: SUMITOMO ELECTRIC INDUSTRIES, LTD., Osaka (JP)

(72) Inventors: Kanako TAKAHASHI, Osaka (JP); Yu KAWAMURA, Osaka (JP); Akito ISHII, Osaka (JP); Masato MICHIUCHI, Osaka (JP); Katsumi OKAMURA, Osaka (JP)

(73) Assignee: SUMITOMO ELECTRIC INDUSTRIES, LTD., Osaka (JP)

(21) Appl. No.: 19/474,904

(22) PCT Filed: Oct. 1, 2024
(86) PCT No.: PCT/JP2024/035042

§ 371 Date: Oct. 13, 2025

(51) Int. Cl. B23B 27/14

(52) U.S. Cl. CPC B23B 27/148; B23B 2226/125

(57) ABSTRACT

A cubic boron nitride sintered body includes 75 vol % to 95 vol % of cubic boron nitride grains and 5 vol % to 25 vol % of a binder material. The cubic boron nitride sintered body has a silicon content of 0.10 atom % to 7 atom %, and the cubic boron nitride sintered body has a cobalt content of 0.5 atom % to 13 atom %.

### TECHNICAL FIELD

The present disclosure relates to a cubic boron nitride sintered body and a cutting tool.

### BACKGROUND ART

A cubic boron nitride sintered body is used as a material for a cutting tool. For example, Patent literature 1 discloses a cubic boron nitride sintered body including 70 vol % to 98 vol % of cubic boron nitride grains and a binder material having a cobalt compound or the like.

### CITATION LIST

### Patent Literature

Patent literature 1: International Publication No. 2005/066381
Patent literature 2: International Publication No. 2023/012858

### SUMMARY OF INVENTION

A cubic boron nitride sintered body according to the present disclosure includes 75 vol % to 95 vol % of cubic boron nitride grains and 5 vol % to 25 vol % of a binder material. The cubic boron nitride sintered body has a silicon content of 0.10 atom % to 7 atom %, and the cubic boron nitride sintered body has a cobalt content of 0.5 atom % to 13 atom %.

### BRIEF DESCRIPTION OF THE DRAWINGS

FIG. 1 is a diagram for explaining planar defects intersecting each other at 90°.

FIG. 2 is a perspective view showing one aspect of the cutting tool according to a second embodiment.

### DETAILED DESCRIPTION

### Problems to be Solved by Present Disclosure

A cutting tool using a cubic boron nitride sintered body including a binder material as a material tend to have wear progression due to the chipping of cubic boron nitride grains and defects due to thermal cracking with use, leading to a reduction in tool life. This tendency is particularly likely to occur when a work material is a sintered alloy, cast iron, or the like.

Patent literature 2 discloses that a cubic boron nitride sintered body including silicon has excellent thermal conductivity. However, the cubic boron nitride sintered body of Patent literature 2 is used as a heat sink, and the strength and toughness thereof are insufficient, so that the cubic boron nitride sintered body cannot be applied to a cutting tool.

Thus, an object of the present disclosure is to provide a cubic boron nitride sintered body which can provide a cutting tool having a long tool life when used as a material of the cutting tool, and a cutting tool including the cubic boron nitride sintered body.

### Advantageous Effects of Present Disclosure

According to the present disclosure, it is possible to provide a cubic boron nitride sintered body which, when used as a material for a cutting tool, can provide a cutting tool having a long tool life, and a cutting tool including the cubic boron nitride sintered body.

### DESCRIPTION OF EMBODIMENTS OF PRESENT DISCLOSURE

First, embodiments of the present disclosure will be listed and described.

(1) A cubic boron nitride sintered body according to the present disclosure includes 75 vol % to 95 vol % of cubic boron nitride grains and 5 vol % to 25 vol % of a binder material. The cubic boron nitride sintered body has a silicon content of 0.10 atom % to 7 atom %, and the cubic boron nitride sintered body has a cobalt content of 0.5 atom % to 13 atom %.

According to the present disclosure, it is possible to provide a cubic boron nitride sintered body which, when used as a material for a cutting tool, can provide a cutting tool having a long tool life.

(2) In the above (1), the binder material may include silicon and cobalt, and the binder material may include one or both of a solid solution of the silicon and the cobalt and a compound having the silicon and the cobalt. According to this, the strength of the binder material is further improved, and the tool life of the cutting tool using the cubic boron nitride sintered body is further improved.

(3) In the above (1) or (2), a first image obtained by elemental analysis of the cubic boron nitride sintered body using an energy dispersive X-ray spectrometer attached to a scanning transmission electron microscope may include a first region where the silicon is present, and a ratio N_{Co}/N_{Si} of a number proportion of cobalt atoms N_{Co} to a number proportion of silicon atoms N_{Si} in the first region may be 0.5 to 120.

In the case of N_{Co}/N_{Si} is 0.5 or more, the strength of the cubic boron nitride sintered body is improved, and the wear resistance is improved. In the case of N_{Co}/N_{Si} is 120 or less, the bonding force between cubic boron nitride grains is improved, the thermal conductivity of the cubic boron nitride sintered body is further improved, and the tool life of a cutting tool using the cubic boron nitride sintered body is further improved.

(4) In the above (3), the N_{Co}/N_{Si} may be 1 to 75. According to this, the thermal conductivity of the cubic boron nitride sintered body is further improved, and the tool life of the cutting tool using the cubic boron nitride sintered body is further improved.

(5) In the above (4), the N_{Co}/N_{Si} may be 1 to 25. According to this, the thermal conductivity of the cubic boron nitride sintered body is further improved, and the tool life of the cutting tool using the cubic boron nitride sintered body is further improved.

(6) In any one of the above (1) to (5), the binder material may include tungsten, and, in an X-ray diffraction pattern of the cubic boron nitride sintered body, a ratio IA/IB of a peak integrated intensity IA of a (420) plane of W₂Co₂₁B₆ to a peak integrated intensity IB of a (111) plane of cubic boron nitride may be 0.05 or less.

W₂Co₂₁B₆ is a by-product produced when a cubic boron nitride sintered body is synthesized. Since W₂Co₂₁B₆ is a brittle compound, it is a factor of decreasing the strength of the cubic boron nitride sintered body. In the case of IA/IB is 0.05 or less, the amount of W₂Co₂₁B₆ in the cubic boron nitride sintered body is reduced. The cubic boron nitride sintered body maintains excellent strength, and a cutting tool using the cubic boron nitride sintered body as a material is further suppressed in the wear progression due to the chipping of the cubic boron nitride grain with use, and the tool life is further improved.

(7) In any one of the above (1) to (6), the cubic boron nitride sintered body may have a first interface region where a distance from a first interface between ones of the cubic boron nitride grains adjacent to each other is within 100 nm, and at least a part of the first interface region may include one or both of cobalt and silicon.

When one or both of cobalt and silicon are present in the first interface region of the cubic boron nitride sintered body, the bonding force between the cubic boron nitride grains is improved. In a cutting tool using the cubic boron nitride sintered body as a material, the wear progression due to the chipping of the cubic boron nitride grain with use is further suppressed, and the tool life is further improved.

(8) In any one of the above (1) to (7), the binder material may include zirconium, the cubic boron nitride sintered body may have a first interface region where a distance from a first interface between ones of the cubic boron nitride grains adjacent to each other is within 100 nm, and at least a part of the first interface region may include zirconium.

In the case of zirconium is present in the first interface region of the cubic boron nitride sintered body, the bonding force between the cubic boron nitride grains is improved. In a cutting tool using the cubic boron nitride sintered body as a material, the wear progression due to the chipping of the cubic boron nitride grain with use is further suppressed, and the tool life is further improved.

(9) In any one of the above (1) to (8), the cubic boron nitride sintered body may have a second interface between one of the cubic boron nitride grains and the binder material adjacent to each other, and when the silicon content is measured in a first direction from the second interface toward an inside of the cubic boron nitride grain, a width D of a region where the silicon content is 0.1 atom % to 1.5 atom % may be 20 nm to 1,000 nm.

The cubic boron nitride grain including silicon in the above amount has a large bonding force with respect to the binder material and the cubic boron nitride grain including no silicon. Thus, in a cutting tool using the cubic boron nitride sintered body including the cubic boron nitride grain as a material, the wear progression due to the chipping of the cubic boron nitride grain with use is further suppressed, and the tool life is further improved.

(10) In any one of the above (1) to (9), a BF-STEM image of a cross section of the cubic boron nitride sintered body may include a second region where cobalt is present, and planar defects intersecting each other at 90° may be present in the second region.

In the cubic boron nitride sintered body obtained by ultra-high pressure sintering, cobalt usually has an fcc structure. In the case of cobalt having the fcc structure, twin defects (70.5°) of a {111} plane are likely to occur. Since the twin defect plane is slippery, the strength of the cobalt in which the planar defect (90°) of the {110} plane presents is higher than that of the cobalt in which the twin defect presents. Thus, in the cutting tool using the cubic boron nitride sintered body including the second region in which the planar defects forming 90° are present as a material, the wear progression due to the chipping of the cubic boron nitride grain with use is further suppressed, and the tool life is further improved.

(11) A cutting tool of the present disclosure is a cutting tool including the cubic boron nitride sintered body according to any one of the above (1) to (10). The cutting tool of the present disclosure can have a long tool life.

### DETAILS OF EMBODIMENTS OF PRESENT DISCLOSURE

Specific examples of a cubic boron nitride sintered body and a cutting tool of the present disclosure will be described below with reference to the drawings. In the drawings of the present disclosure, like reference numerals designate like or corresponding parts. Further, dimensional relationships such as length, width, thickness, and depth are appropriately changed for the sake of clarity and simplification of the drawings, and do not necessarily represent actual dimensional relationships.

In the present disclosure, the notation in the form of “A to B” means equal to or more than A and equal to or less than B, and in the case where no unit is described for A and a unit is described only for B, the unit of A and the unit of B are the same.

In the present disclosure, when compounds are expressed in chemical formulas, unless an atomic ratio is particularly limited, it is to be understood as including any known atomic ratios and should not necessarily be limited to those in a stoichiometric ranges.

Where the present disclosure recites one or more numerical values as lower and upper numerical range limits, it is intended that the combination of any single numerical value recited in the lower limit and any single numerical value recited in the upper limit is also disclosed.

In the present disclosure, “comprising”, “including”, “having” and variations thereof are open-ended terms. Open ended terms may or may not include additional elements in addition to the essential elements. The phrase “consisting of” is a closed term. However, even a configuration expressed by a closed term may include an additional element which is an impurity usually accompanied or is not related to the target technology.

### First Embodiment: Cubic Boron Nitride Sintered Body

A cubic boron nitride sintered body according to the one embodiment (hereinafter, also referred to as a “first embodiment”) of the present disclosure is a cubic boron nitride sintered body including 75 vol % to 95 vol % of cubic boron nitride grains and 5 vol % to 25 vol % of a binder material. The cubic boron nitride sintered body has a silicon content of 0.10 atom % to 7 atom % The cubic boron nitride sintered body has a cobalt content of 0.5 atom % to 13 atom %.

### <Composition of Cubic Boron Nitride Sintered Body>

### <<Content of Cubic Boron Nitride Grain>>

A content of cubic boron nitride grain in the cubic boron nitride sintered body of the first embodiment is 75 vol % to 95 vol %, may be 80 vol % to 95 vol %, or may be 85 vol % to 90 vol %. In the case of the content of the cubic boron nitride grain is 75 vol % or more, the cubic boron nitride grains are likely to come into contact with each other, and the effect of improving the bonding force between the cubic boron nitride grains by silicon is likely to be obtained. In the case of the content of the cubic boron nitride grain is more than 95 vol %, the cubic boron nitride sintered body cannot be produced due to the lack of the binder material.

### <<Content of Binder Material>>

The content of the binder material in the cubic boron nitride sintered body of the first embodiment is 5 vol % to 25 vol %, may be 5 vol % to 20 vol %, or may be 10 vol % to 15 vol %. In the case of the content of the binder material is 5 vol % or more, the cubic boron nitride sintered body can have sufficient toughness. In the case of the content of the binder material is 25 vol % or less, the cubic boron nitride sintered body can have sufficient wear resistance.

The total content of the cubic boron nitride and the binder material in the cubic boron nitride sintered body may be 99 vol % to 100 vol %, 99 vol % to 99.99 vol %, or 99.90 vol % to 99.99 vol %.

The content (vol %) of the cubic boron nitride grain and the content (vol %) of the binder material in the cubic boron nitride sintered body can be confirmed by performing structure observation, elemental analysis, and the like on the cubic boron nitride sintered body using an energy dispersive X-ray analyzer (EDX) (Octane Elect EDS system) (hereinafter, also referred to as “SEM-EDX”) attached to a scanning electron microscopy (SEM) (“JSM-7800F” (trade name) manufactured by JEOL Ltd.). The specific measurement method is as follows.

The cubic boron nitride sintered body is cut at any position to produce a sample including a cross section of the cubic boron nitride sintered body. For the production of the cross section, a focused ion beam apparatus, a cross section polisher apparatus, or the like can be used. Next, the cross section is observed with the SEM to obtain a backscattered electron image. In the backscattered electron image, a region where the cubic boron nitride grain is present is a black region, and a region where the binder material is present is a gray region or a white region. The magnification of the SEM is appropriately set in accordance with a circle equivalent diameter d50 of the cubic boron nitride grain. The magnification is 5,000 times when the circle equivalent diameter d50 of the cubic boron nitride grain is 5 μm or less, 1,000 times when the circle equivalent diameter d50 is more than 5 μm and 20 μm or less, and 100 times when the circle equivalent diameter d50 is more than 20 μm and about 100 μm.

Next, binarization processing is performed on the backscattered electron image using image analysis software (“WinROOF” by MITANI CORPORATION). The threshold value for binarization varies depending on contrast, and is thus set for each image. From the image after the binarization processing, the area ratio of the pixels derived from the dark field (pixels derived from the cubic boron nitride grain) to the area of the measurement field is calculated. By regarding the calculated area ratio as vol %, the content (vol %) of the cubic boron nitride grain in the cubic boron nitride sintered body can be obtained.

The content (vol %) of the binder material in the cubic boron nitride sintered body can be determined by calculating the area ratio of the pixels derived from the bright field (pixels derived from the binder material) to the area of the measurement field from the image after the binarization processing.

In the image after the binarization processing, it is confirmed that the pixels derived from the dark field are derived from the cubic boron nitride grain and the pixels derived from the bright field are derived from the binder material by performing elemental analysis by the SEM-EDX on the same field as the image after the binarization processing on the cross section of the cubic boron nitride sintered body to obtain an elemental mapping image.

It has been confirmed that, in the same cubic boron nitride sintered body, even when the content (vol %) of the cubic boron nitride grain and the content (vol %) of the binder material are measured a plurality of times by changing the selected portion of the measurement field, there is almost no variation in the measurement results.

The cubic boron nitride sintered body of the first embodiment may be consisted of a cubic boron nitride grain and a binder material. The cubic boron nitride sintered body of the first embodiment may include inevitable impurities as long as the effects of the present disclosure are not impaired. The cubic boron nitride sintered body of the first embodiment may be consisted of a cubic boron nitride grain, a binder material, and inevitable impurities.

The inevitable impurities are components that are not included in starting materials and are inevitably mixed as impurities in the production process. The content of the inevitable impurities may be 0.1 mass % or less. The content by amount of the inevitable impurities can be measured by a high-frequency induction plasma emission spectrometry (ICP analysis) and an inert gas melting method (gas analysis).

### <<Content of Silicon>>

The content of silicon in the cubic boron nitride sintered body of the first embodiment is 0.10 atom % to 7 atom %, may be 0.10 atom % to 7.0 atom %, may be 0.5 atom % to 6.6 atom %, may be 0.7 atom % to 3.0 atom %, or may be 0.75 atom % to 3.0 atom %. In the case of the content of silicon is 0.10 atom % or more, the bonding force between cubic boron nitride grains is improved, and the cubic boron nitride sintered body can have high thermal conductivity. In the case of the content of silicon is 7 atom % or less, the cubic boron nitride sintered body can have sufficient toughness.

The measurement method of the content of silicon in the cubic boron nitride sintered body is as follows. A sample is collected from the cubic boron nitride sintered body, and a slice having a thickness of 30 to 100 nm is produced from the sample using an argon ion slicer. The test slice is subjected to elemental analysis using an energy dispersive X-ray spectrometer (STEM-EDX) attached to a scanning transmission electron microscope to obtain an elemental mapping image. The observation magnification is 20,000 times. The region for which the elemental analysis is performed is the entire measurement field. For example, “JEM-ARM300F2” (product name) manufactured by JEOL Ltd. is used as the apparatus. The above measurement is performed in five different measurement fields that do not overlap with each other. In the present disclosure, the average of the content of silicon in the cubic boron nitride sintered body in the five measurement fields corresponds to the content of silicon in the cubic boron nitride sintered body. In the present disclosure, the content of cobalt in the cubic boron nitride sintered body described below is also measured by the same method.

At least a part of silicon included in the cubic boron nitride sintered body may be present in the binder material. The silicon present in the binder material may be 50% to 99.9% of the silicon included in the cubic boron nitride sintered body.

### <<<<Content of Cobalt>>

The content of cobalt in the cubic boron nitride sintered body of the first embodiment is 0.5 atom % to 13 atom %, may be 1.0 atom % to 12 atom %, or may be 1.5 atom % to 7 atom %. In the case of the content of cobalt is 0.5 atom % or more, the cubic boron nitride sintered body can have sufficient toughness. In the case of the content of cobalt is 13 atom % or less, the cubic boron nitride sintered body can have sufficient wear resistance. In the case of the content of cobalt is more than 13 atom %, the content of silicon in the cubic boron nitride sintered body is reduced, and thus the bonding force between the cubic boron nitride grains is reduced, and the strength of the cubic boron nitride sintered body is reduced.

At least a part of the cobalt included in the cubic boron nitride sintered body may be present in the binder material. The amount of cobalt present in the binder material among the cobalt included in the cubic boron nitride sintered body may be 80% to 100%.

<Cubic Boron Nitride Grain> In the cubic boron nitride sintered body of the first embodiment, the cubic boron nitride grain includes cubic boron nitride as a main component. The content of cubic boron nitride in the cubic boron nitride grain may be 99.9 mass % or more.

In the cubic boron nitride sintered body of the first embodiment, the circle equivalent diameter d50 of the cubic boron nitride grain may be 0.1 μm to 100 μm, 0.2 μm to 15 μm, or 0.3 μm to 5 μm. In the case of the circle equivalent diameter d50 of the cubic boron nitride grain is 0.1 μm or more, the thermal conductivity of the cubic boron nitride sintered body is further improved. In the case of the circle equivalent diameter d50 of the cubic boron nitride grain is 100 μm or less, the hardness of the cubic boron nitride sintered body is improved. In the present disclosure, the circle equivalent diameter d50 of the cubic boron nitride grain means the circle equivalent diameter at which the cumulative frequency based on the number becomes 50%.

The circle equivalent diameter d50 of the cubic boron nitride grain obtains an image after the binarization processing, using the same method as that for measuring the content of cubic boron nitride in the cubic boron nitride sintered body measured by the following procedure.

A measurement field is set in the image after the binarization processing. The size of the measurement field is set such that the number of cubic boron nitride grains in the measurement field is 500 to 800. In a state where the grain boundary of the cubic boron nitride grain observed in the measurement field is separated, the distribution of the circle equivalent diameter of the cubic boron nitride grain is measured using the image processing software. The measurement field is set at five positions.

Based on the distribution of the circle equivalent diameter of the cubic boron nitride grain, the circle equivalent diameter d50 of the cubic boron nitride grain is obtained with the number of all cubic boron nitride grains in the measurement field as the denominator. In each of the five measurement fields, the circle equivalent diameter d50 of the cubic boron nitride grain is obtained, and the mean value thereof is calculated. The mean value corresponds to the circle equivalent diameter d50 of the cubic boron nitride grain.

As long as the measurement is performed on the same sample, it was confirmed that there is almost no variation in the measurement results even when the measurement field is set and the measurement of the circle equivalent diameter d50 of the cubic boron nitride grain is performed a plurality of times according to the above procedure.

### <Binder Material>

### <<Presence Form of Silicon and Cobalt>>

The binder material of the cubic boron nitride sintered body of the first embodiment may include silicon and cobalt. The binder material may include one or both of a solid solution of silicon and cobalt and a compound having silicon and cobalt. Examples of the compound having silicon and cobalt include Co₂Si, CoSi, and CoSi₂.

It is confirmed by using an X-ray diffraction method and the STEM-EDX that the binder material of the cubic boron nitride sintered body includes one or both of a solid solution of silicon and cobalt and a compound including silicon and cobalt. First, a test slice having a thickness of about 1.0 mm to 2.0 mm is cut out from a cubic boron nitride sintered body. The test slice is subjected to the XRD analysis using an X-ray diffractometer to obtain an X-ray diffraction spectrum. The measurement conditions are as follows.
X-ray diffractometer: trade name “MiniFlex600”, manufactured by Rigaku
Holdings Corporation
Characteristic X-ray: Cu-Kα (wavelength 1.54 Å)
Tube voltage: 40 kV
Tube current: 15 mA
Filter: K-β filter
Optical system: focusing method
X-ray diffraction method: θ-2θ method

When a compound peak (Co₂Si: 2θ=45.5°±0.5°, CoSi: 2θ=45.2°±0.5°, CoSi₂:2θ=48.3°±0.5°) having silicon and cobalt is present in the X-ray diffraction spectrum, it is determined that a compound having silicon and cobalt is present.

An STEM-EDX elemental mapping image is obtained by the same method as the measurement method of the content of silicon in the cubic boron nitride sintered body. When silicon and cobalt is present at the same position in the STEM-EDX elemental mapping image, it is determined that a solid solution of silicon and cobalt are present.

In the cubic boron nitride sintered body of the first embodiment, the cobalt may be present as simple cobalt.

In the cubic boron nitride sintered body of the first embodiment, silicon may be present as simple silicon or may be present as a silicon compound produced by reacting silicon with other elements included in the cubic boron nitride sintered body. Examples of the silicon compound include silicon boride (SiB₆), silicon nitride (SiN), silicon oxide (SiO₂), and silicon carbide (SiC).

In the cubic boron nitride sintered body of the first embodiment, the content of cobalt in the binder material may be 2 atom % to 99 atom %, 10 atom % to 99 atom %, or 15 atom % to 99 atom %.

In the cubic boron nitride sintered body of the first embodiment, the content of silicon in the binder material may be 0.5 atom % to 80 atom %, 1.0 atom % to 70 atom %, or 1.0 atom % to 60 atom %.

In the cubic boron nitride sintered body of the first embodiment, the binder material may include zirconium. According to this, the bonding force between cubic boron nitride grains is improved. The content of zirconium in the binder material may be 0.00 atom % to 2.0 atom %, 0.01 atom % to 1.5 atom %, or 0.01 atom % to 1.0 atom %.

In the cubic boron nitride sintered body of the first embodiment, the binder material includes cobalt and silicon. The binder material may include components conventionally known as a binder material in addition to cobalt and silicon. Examples of the component include aluminum, nickel, iron, chromium, manganese, titanium, vanadium, niobium, molybdenum, hafnium, tantalum, and rhenium.

<N_{Co}/N_{Si}> A first image obtained by performing elemental analysis on the cubic boron nitride sintered body of the first embodiment using an energy dispersive X-ray spectrometer attached to a scanning transmission electron microscope may include a first region in which silicon is present. The ratio N_{Co}/N_{Si} of the number proportion of cobalt atoms N_{Co} to the number proportion of silicon atoms N_{Si} in the first region may be 0.5 to 120, may be 1 to 75, or may be 1 to 25.

The measurement method of the ratio N_{Co}/N_{Si} of the number proportion of cobalt atoms N_{Co} to the number proportion of silicon atoms N_{Si} in the first region is as follows. First, a sample is collected from the cubic boron nitride sintered body, and a slice having a thickness of 30 to 100 nm is produced from the sample using an argon ion slicer. An elemental mapping image is obtained by performing elemental analysis on the test slice using an energy dispersive X-ray spectrometer (STEM-EDX) attached to a scanning transmission electron microscope. The elemental mapping image corresponds to the first image. The observation magnification is 20,000 times. When the grain size of the cubic boron nitride grain is large and the binder material does not enter the measurement field at 20,000 times, the measurement is performed by lowering the magnification until about 10 cubic boron nitride grains are included in the measurement field.

The region for which the elemental analysis is performed is the entire measurement field. In the elemental mapping image (first image), a first region where silicon is present is specified. In the first region, the ratio N_{Co}/N_{Si} of the number proportion of cobalt atoms N_{Co} to the number proportion of silicon atoms N_{Si} is measured. The above measurement is performed in 10 different measurement fields that do not overlap with each other. In the present disclosure, the average of N_{Co}/N_{Si} of 10 measurement fields corresponds to the ratio N_{Co}/N_{Si} of the number proportion of cobalt atoms N_{Co} to the number proportion of silicon atoms N_{Si} in the first region.

As long as the measurement is performed on the same sample, it was confirmed that there is almost no variation in the measurement result even when the measurement field is set and the measurement of N_{Co}/N_{Si} is performed a plurality of times according to the above procedure.

<Ratio IA/IB of Peak Integrated Intensity IA of (420) Plane of W₂Co₂₁B₆ to Peak Integrated Intensity IB of (111) Plane of Cubic Boron Nitride>

The binder material of the cubic boron nitride sintered body of the first embodiment may include tungsten, and in an X-ray diffraction pattern of the cubic boron nitride sintered body, a ratio IA/IB of a peak integrated intensity IA of a (420) plane of the W₂Co₂₁B₆ to a peak integrated intensity IB of a (111) plane of the cubic boron nitride may be 0.05 or less. IA/IB may be 0.01 to 0.04, or may be 0.01 to 0.03.

The measurement method of the IA/IB is as follows. First, a test slice having a thickness of about 1.0 to 2.0 mm is cut out from a cubic boron nitride sintered body. The test slice is subjected to XRD analysis using an X-ray diffractometer (“MiniFlex600” (trade name) manufactured by Rigaku Holdings Corporation) to obtain an X-ray diffraction spectrum. The measurement conditions are as follows.

X-ray diffractometer: trade name “MiniFlex600”, manufactured by Rigaku Holdings Corporation
Characteristic X-ray: Cu-Kα (wavelength 1.54 Å)
Tube voltage: 40 kV
Tube current: 15 mA
Filter: K-β filter
Optical system: focusing method
X-ray diffraction method: θ-2θ method

Based on the X-ray diffraction spectrum, the peak integrated intensity IA of the (420) plane of W₂Co₂₁B₆ and the peak integrated intensity IB of the (111) plane of cubic boron nitride are measured. In the X-ray diffraction spectrum, the peak of the (420) plane of the W₂Co₂₁B₆ is confirmed at 2θ=38.2°±0.15°. In the X-ray diffraction spectrum, the peak of the (111) plane of the cubic boron nitride is confirmed at 2θ=43.3°±0.15°. Based on the peak integrated intensity IA and the peak integrated intensity IB, IA/IB is calculated.

As long as the measurement is performed on the same sample, it was confirmed that there is almost no variation in the measurement result even when the measurement of IA/IB is performed a plurality of times according to the above procedure.

### <First Interface Region>

The cubic boron nitride sintered body of the first embodiment may have a first interface region where a distance from a first interface between ones of the cubic boron nitride grains adjacent to each other is within 100 nm. At least a part of the first interface region may include one or both of cobalt and silicon.

In the present disclosure, the fact that the cubic boron nitride sintered body includes the first interface region and at least a part of the first interface region includes one or both of cobalt and silicon is confirmed by the following procedure using the STEM-EDX.

A sample is collected from the cubic boron nitride sintered body, and a slice having a thickness of 30 to 100 nm is produced from the sample using an argon ion slicer. Then, the slice is observed with a scanning transmission electron microscope (STEM) at a magnification of 50,000 times to obtain a first image. An example of the transmission electron microscopy used at this time is “JEM-ARM300F2” (product name) manufactured by JEOL Ltd. In the first image, a first interface between ones of the cubic boron nitride grains adjacent to each other is selected. Next, the selected first interface is positioned so as to pass through near the center of the image, and the observation magnification is changed to 100,000 times to perform observation, thereby obtaining a second image.

In the second image, the first interface region where distance from the first interface is within 100 nm is identified. In other words, when two cubic boron nitride grains forming the first interface are a first cubic boron nitride grain and a second cubic boron nitride grain, the first interface region is consisted of a region interposed between the first interface and a virtual line having a distance of 100 nm from the first interface to the first cubic boron nitride grain side, and a region interposed between the first interface and a virtual line having a distance of 100 nm from the first interface to the second cubic boron nitride grain side.

In the second image, an expanding direction in which the first interface is expanded is confirmed. In the first interface region, an elemental line analysis is performed in a direction substantially perpendicular to the expanding direction using an energy dispersive X-ray spectrometer (STEM-EDX) attached to a scanning transmission electron microscope. The beam diameter is set to 0.3 nm or less, and the scan interval is set to 0.1 to 0.7 nm.

From the result of the elemental line analysis, it is confirmed that the cubic boron nitride sintered body includes the first interface region, and at least a part of the first interface region includes one or both of cobalt and silicon, when one or both of cobalt and silicon are present in the first interface region.

When the above analysis is repeatedly performed on the first images of the six fields and it is confirmed that at least a part of the first interface region includes one or both of cobalt and silicon in one or more fields, the cubic boron nitride sintered body has the first interface region where a distance from a first interface between ones of the cubic boron nitride grains adjacent to each other is within 100 nm, and it is determined that at least a part of the first interface region includes one or both of cobalt and silicon.

As long as the measurement is performed on the same sample, it was confirmed that there is almost no variation in the result even when the measurement field is set and the above confirmation is performed a plurality of times according to the above procedure.

The binder material of the cubic boron nitride sintered body of the first embodiment may include zirconium. The cubic boron nitride sintered body may have a first interface region where a distance from a first interface between ones of the cubic boron nitride grains adjacent to each other is within 100 nm. At least a part of the first interface region may include zirconium.

In the present disclosure, the cubic boron nitride sintered body includes the first interface region, and at least a part of the first interface region includes zirconium, which is confirmed by the same method as the method for confirming that at least a part of the first interface region includes one or both of cobalt and silicon.

### <Second Interface>

The cubic boron nitride sintered body of the first embodiment may have a second interface between one of the cubic boron nitride grains and the binder material adjacent to each other. When the silicon content is measured in a first direction from the second interface toward the inside of the cubic boron nitride grain, a width D of a region where the silicon content is 0.1 atom % to 1.5 atom % may be 20 nm to 1,000 nm. This indicates that a region having a silicon content of 0.1 atom % to 1.5 atom % is present in the peripheral portion of the cubic boron nitride grain, and the region is thicker than 20 nm and is 1,000 nm.

In the case of the width D of the region having a silicon content of 0.1 atom % or more is 20 nm or more, the bonding force to the binder material and the cubic boron nitride grain not including silicon is large. In the case of the content of silicon in the cubic boron nitride grain is too large, defects tend to occur in the cubic boron nitride grain, resulting in a decrease in strength. In consideration of this point, when the content of silicon is 1.5 atom % or less and the width D is 1,000 nm or less, the cubic boron nitride sintered body can have excellent strength.

In the present disclosure, the measurement of the width D is performed by the STEM-EDX. The specific measurement method is as follows. A first image is obtained by the same method as the measurement by the STEM-EDX of the first interface region. In the first image, a second interface between the cubic boron nitride grain and the binder material adjacent to each other is selected. Next, the selected second interface is positioned so as to pass through near the center of the image, and the observation magnification is changed to 100,000 times to perform observation, thereby obtaining a third image.

In the third image, the expanding direction in which the second interface is expanded is confirmed, and the elemental line analysis is performed along a direction substantially perpendicular to the expanding direction and along the first direction from the second interface toward the inside of the cubic boron nitride grain. The beam diameter is set to 0.3 nm or less, and the scan interval is set to 0.1 to 0.7 nm.

From the result of the elemental line analysis, the width D of the region where the content of silicon is 0.1 atom % to 1.5 atom % is calculated. Here, the content of silicon is measured at each beam spot. The content of silicon is determined by setting the total element measured at each peak spot to 100 atom %.

The above analysis is repeated on the first images of the six fields, and when the width D is 20 nm to 1,000 nm in one or more fields, the width D of the regions of the cubic boron nitride sintered body where the content of silicon is 0.1 atom % to 1.5 atom % are determined to be 20 nm to 1,000 nm.

### <Planar Defect in Second Region>

A BF-STEM image of the cross section of the cubic boron nitride sintered body of the first embodiment may include a second region where cobalt is present, and planar defects intersecting each other at 90° may be present in the second region.

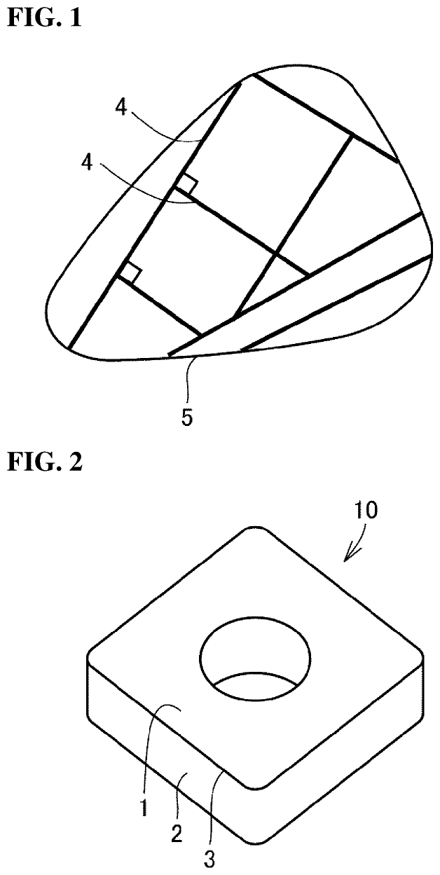

In the present disclosure, the BF-STEM image of the cross section of the cubic boron nitride sintered body includes the second region where cobalt is present, and the planar defects intersecting each other at 90° in the second region are confirmed by the following procedure. The elemental mapping image (first image) is obtained by the same method as the measurement method of N_{Co}/N_{Si} in the first region. In the first image, the second region where cobalt is present is specified. In the first image, a portion corresponding to the second region is selected, and the BF-STEM image enlarged 50,000 times to 100,000 times so that the portion is located at the center is set as the second image. Streak-like patterns intersecting each other at 90° are identified at a position corresponding to the second region in the second image. The streak-like pattern corresponds to a planar defect. FIG. 1 is a view for explaining streak-like patterns intersecting each other at 90°. In FIG. 1, streak-like patterns 4 are present in a second region 5 intersecting each other at 90°. The observation described above is repeatedly performed based on the first images of 10 fields, and when streak-like patterns intersecting each other at 90° with each other are observed in the second region in five or more fields, it is determined that the BF-STEM image of the cross section of the cubic boron nitride sintered body includes the second region in which cobalt is present, and planar defects intersecting each other at 90° are present in the second region.

### <Method of Manufacturing Cubic Boron Nitride Sintered Body>

The cubic boron nitride sintered body of the first embodiment can be produced by, for example, the following method.

### <<Raw Material Preparation Step>>

As raw materials, cubic boron nitride powder (hereinafter, also referred to as “cBN powder”), silicon powder, cobalt powder, and tungsten carbide powder (hereinafter, also referred to as “WC powder”) are prepared. The average grain size of the cubic boron nitride powder is 0.2 to 100 μm. The average grain size of the silicon powder is 0.5 to 10 μm. The average grain size of the cobalt powder is 0.2 to 5 μm. The average grain size of the WC powder is 0.2 to 5 μm. In this specification, the average grain size of a raw material powder means a median size d50 of the sphere equivalent diameters. The average grain size is measured using a particle size distribution analyzer (trade name: MT3300EX) manufactured by MicrotracBEL Corp.

The cBN powder may be subjected to a heat treatment in a nitrogen atmosphere at 1,400 to 1,600° C. for 30 to 300 minutes.

Cobalt or silicon may be adhered on the surface of the cBN powder after the heat treatment. As this method, an arc plasma powder method (APD method) is exemplified. The conditions of the APD method are as follows.

Coating apparatus: nanoparticle forming apparatus APD-P manufactured by ADVANCE RIKO, Inc.
Target: cobalt or silicon
Introduced gas: after evacuation of 10⁻⁴ Pa, argon gas is introduced and the
inner pressure of the apparatus is set to 10⁻¹ Pa.
Discharge voltage: 200 V
Discharge frequency: 6 Hz
Capacitor capacitance: 1080 μF
Number of shots: 5,000
Amount of powder treated: 25 g
Rotational speed of powder vessel: 50 rpm

As the cobalt powder and the silicon powder, powders obtained by mixing and pulverizing the cobalt powder and the silicon powder in a ball mill in advance can be used. The pulverizing time is 12 to 24 hours.

As the zirconium source, zirconium carbide powder, zirconium nitride powder, or the like can be prepared. The average grain size of the zirconium carbide powder and the zirconium nitride powder is 1 to 5 μm. As a raw material powder other than the above, a powder including a conventionally known component (Ni, Fe, Cr, Mo, Ti, V, Nb, Mo, Hf, Ta, or Re) as a binder material may be prepared.

### <<Mixing Step>>

The cBN powder, the silicon powder, the cobalt powder, the WC powder, and optionally other raw material powders are mixed to obtain a mixed powder. The mass ratio of the silicon powder to the cobalt powder in the mixed powder is silicon powder: cobalt powder=5:1 to 1:275.

The mixing method is not particularly limited. From the viewpoint of efficient and homogeneous mixing, ball mill mixing, bead mill mixing, planetary mill mixing, or jet mill mixing may be used. Each mixing method may be a wet method or a dry method.

### <<Sintering Step>>

Next, the mixed powder is encapsulated in a tantalum capsule, and the mixed powder is heated and pressurized to temperatures of 1,500 to 2,000° C. and pressures of 5 to 8 GPa using a belt-type high-pressure and high-temperature generating device, and held for 5 to 50 minutes to obtain a cubic boron nitride sintered body.

### Second Embodiment: Cutting Tool

A cutting tool according to one embodiment (hereinafter, also referred to as a “second embodiment”) of the present disclosure is a cutting tool including the cubic boron nitride sintered body of the first embodiment.

The cutting tool including the cubic boron nitride sintered body of the first embodiment may be entirely formed of the cubic boron nitride sintered body, or only the cutting edge portion may be formed of the cubic boron nitride sintered body. Further, a coating film may be formed on the surface of the cutting tool. In the present disclosure, the cutting edge portion means a portion which is involved in cutting. To be specific, the cutting edge means a region surrounded by a cutting edge ridge line and a virtual surface in which a distance from the cutting edge ridge line to the cubic boron nitride sintered body side is 0.5 mm.

Examples of the cutting tool include a drill, an end mill, a cutting edge replaceable cutting tip for a drill, a cutting edge replaceable cutting tip for an end mill, a cutting edge replaceable cutting tip for milling, a cutting edge replaceable cutting tip for turning, a metal saw, a gear cutting tool, a reamer, a tap, and a cutting bite. FIG. 2 is a perspective view showing one aspect of a cutting tool according to the second embodiment. A cutting tool 10 includes a rake face 1, a flank face 2, and a cutting edge ridge line portion 3 where the rake face 1 and the flank face 2 intersect. The cutting tool 10 is used as, for example, a cutting edge replaceable cutting insert.

The cubic boron nitride sintered body of the first embodiment may be used as a material for a wear resistant tool or a grinding tool. Examples of wear resistant tools include dies, scribers, scribing wheels, and dressers. Examples of the grinding tool include a grinding wheel.

### EXAMPLE

The present embodiment will be described more specifically by way of examples. However, the present embodiment is not limited to these examples.

### <Production of Cubic Boron Nitride Sintered Body>

### <<Raw Material Preparation Step>>

The average grain size of the cubic boron nitride (cBN) powder is shown in Table 1 and Table 2.), silicon (Si) powder (average grain size of 1 μm), cobalt (Co) powder (average grain size of 0.5 μm), WC powder (average grain size of 0.5 μm), and ZrC powder (average grain size of 2.5 μm) were prepared.

In the samples in which the temperature and time are described in the column of “cBN powder heat treatment” in Table 1 and Table 2, the cBN powder was subjected to heat treatment in a nitrogen atmosphere at the temperature and time described in the tables. The samples indicated by “-” were not subjected to heat treatment.

In the samples described as “APD” in the column “cBN powder surface treatment” in Table 1 and Table 2, cobalt or silicon was adhered to the surface of the cBN powder by the APD method. The specific method is as described in the first embodiment. In the samples described as “-”, the APD method was not performed.

In the samples in which “Presence” is described in the “Co/Si pre-pulverization” column of Table 1 and Table 2, powder obtained by mixing and pulverizing cobalt powder and silicon powder in advance by a ball mill was used. The grinding time was 24 hours.

### <<Mixing Step>>

The raw material powders were mixed in mass % (the entire mixed powder was set to 100 mass %) described in Table 1 and Table 2 to obtain a mixed powder. The mixing was performed for 10 minutes using a planetary mill (bead diameter φ of 0.3 mm).

<<Sintering Step>>

Next, the mixed powder was encapsulated in a tantalum capsule, and the mixed powder was pressurized to 6.5 GPa at a sintering temperature shown in Table 1 and Table 2 using a belt-type high-pressure high-temperature generating apparatus and held for 30 minutes to obtain a cubic boron nitride sintered body of each sample.

TABLE 1

| | | | | | cBN powder | | | Co/Si pre- | |
|---|---|---|---|---|---|---|---|---|---|
| | | | | | Average | | | pulverization | Sintering |
| Sample | Raw material powder (mass %) | | | | grain size | Heat | Surface | Presence or | temperature |
| No. | cBN | Co | Si | WC | μm | treatment | treatment | Absence | ° C. |
| 1 | 55.72 | 40.23 | 1.47 | 2.57 | 3 | — | — | Absence | 1700 |
| 2 | 70.25 | 5.59 | 12.41 | 11.76 | 3 | — | — | Absence | 1700 |
| 3 | 79.47 | 12.10 | 5.76 | 2.68 | 3 | — | — | Absence | 1700 |
| 4 | 78.74 | 19.84 | 1.42 | 0.00 | 3 | — | — | Absence | 1700 |
| 5 | 83.19 | 2.03 | 0.19 | 14.58 | 3 | — | — | Absence | 1700 |
| 6 | 75.60 | 11.92 | 12.48 | 0.00 | 3 | — | — | Absence | 1700 |
| 1-1 | 62.96 | 26.10 | 10.94 | 0.00 | 3 | — | — | Absence | 1700 |
| 1-2 | 95.74 | 2.29 | 0.44 | 1.52 | 3 | — | — | Absence | 1700 |
| 1-3 | 74.77 | 1.12 | 1.78 | 22.34 | 3 | — | — | Absence | 1700 |
| 1-4 | 54.40 | 42.50 | 0.58 | 2.52 | 3 | — | — | Absence | 1700 |
| 1-5 | 73.01 | 11.02 | 0.09 | 15.88 | 3 | — | — | Absence | 1700 |
| 1-6 | 80.82 | 2.11 | 17.07 | 0.00 | 3 | — | — | Absence | 1700 |
| 7 | 73.53 | 4.79 | 0.88 | 20.81 | 3 | — | — | Absence | 1700 |
| 8 | 79.30 | 5.13 | 2.44 | 13.12 | 3 | — | — | Absence | 1700 |
| 9 | 75.14 | 1.88 | 1.79 | 21.20 | 3 | — | — | Absence | 1700 |
| 10 | 68.56 | 1.82 | 12.11 | 17.51 | 3 | — | — | Absence | 1700 |
| 11 | 50.94 | 34.23 | 0.14 | 14.69 | 3 | — | — | Absence | 1700 |
| 12 | 73.51 | 26.31 | 0.18 | 0.00 | 3 | — | — | Absence | 1700 |
| 13 | 71.21 | 7.17 | 0.17 | 21.45 | 3 | — | — | Absence | 1700 |
| 14 | 70.81 | 5.34 | 0.17 | 23.68 | 3 | — | — | Absence | 1700 |
| 15 | 51.92 | 37.80 | 0.14 | 10.15 | 3 | — | — | Absence | 1700 |
| 16 | 69.11 | 17.79 | 1.27 | 11.82 | 0.2 | — | — | Absence | 1700 |
| 17 | 69.11 | 17.79 | 1.27 | 11.82 | 10 | — | — | Absence | 1700 |
| 18 | 69.11 | 17.79 | 1.27 | 11.82 | 100 | — | — | Absence | 1700 |

TABLE 2

| | | | | | | cBN powder | | | Co/Si pre- | |
|---|---|---|---|---|---|---|---|---|---|---|
| | | | | | | Average | | | pulverization | Sintering |
| Sample | Raw material powder (mass %) | | | | | grain size | Heat | Surface | Presence or | temperature |
| No. | cBN | Co | Si | WC | ZrC | μm | treatment | treatment | Absence | ° C. |
| 19 | 68.12 | 17.58 | 1.26 | 12.86 | 0.18 | 3 | — | — | Absence | 1700 |
| 20 | 68.12 | 17.58 | 1.26 | 12.86 | 0.18 | 3 | — | — | Absence | 1725 |
| 21 | 68.12 | 17.58 | 1.26 | 12.86 | 0.18 | 3 | — | — | Absence | 1750 |
| 22 | 68.12 | 17.58 | 1.26 | 12.86 | 0.18 | 3 | — | — | Absence | 1800 |
| 23 | 68.12 | 17.58 | 1.26 | 12.86 | 0.18 | 3 | — | APD | Absence | 1700 |
| 24 | 68.12 | 17.58 | 1.26 | 12.86 | 0.18 | 3 | — | APD | Absence | 1700 |
| 25 | 68.12 | 17.58 | 1.26 | 12.86 | 0.18 | 3 | — | APD | Absence | 1700 |
| 26 | 68.12 | 17.58 | 1.26 | 12.86 | 0.18 | 3 | — | APD | Absence | 1700 |
| 27 | 68.12 | 17.58 | 1.26 | 12.86 | 0.18 | 3 | — | APD | Absence | 1700 |
| 28 | 68.12 | 17.58 | 1.26 | 12.86 | 0.18 | 3 | 1400° C., | — | Absence | 1700 |
| | | | | | | | 30 min | | | |
| 29 | 68.12 | 17.58 | 1.26 | 12.86 | 0.18 | 3 | 1500° C., | — | Absence | 1700 |
| | | | | | | | 2 h | | | |
| 30 | 68.12 | 17.58 | 1.26 | 12.86 | 0.18 | 3 | 1500° C., | — | Absence | 1700 |
| | | | | | | | 5 h | | | |
| 31 | 68.12 | 17.58 | 1.26 | 12.86 | 0.18 | 3 | 1600° C., | — | Absence | 1700 |
| | | | | | | | 1 h | | | |
| 32 | 68.12 | 17.58 | 1.26 | 12.86 | 0.18 | 3 | — | — | Presence | 1700 |
| 33 | 68.12 | 17.58 | 1.26 | 12.86 | 0.18 | 3 | 1500° C., | APD | Presence | 1700 |
| | | | | | | | 2 h | | | |

### [Evaluation of Cubic Boron Nitride Sintered Body]

### <Composition and Structure>

In the cubic boron nitride sintered body of each sample, the content of cubic boron nitride grain (cBN grain), the content of binder material, the content of silicon (Si), the content of cobalt (Co), and the circle equivalent diameter d50 of the cubic boron nitride grain (cBN grain) were measured by the method described in the first embodiment. The results are shown in Table 3 and Table 4.

In all samples, the binder material of the cubic boron nitride sintered body included silicon and cobalt. In each of Sample 1 to Sample 33, the amount of silicon present in the binder material was 50% to 99.9% of the amount of silicon included in the cubic boron nitride sintered body. In Sample 1 to Sample 33, the amount of cobalt present in the binder material was 80% to 100% of the amount of cobalt included in the cubic boron nitride sintered body. In each sample, the presence form of silicon and cobalt in the binder material was confirmed by the method described in the first embodiment. The results are shown in Table 3 and Table 4. The term “solid solution” means a solid solution of silicon and cobalt.

The cubic boron nitride sintered body of each sample was subjected to elemental analysis using an energy dispersive X-ray spectrometer attached to a scanning transmission electron microscope by the method described in the first embodiment to obtain a first image. In all samples, the first image included the first region where silicon was present. In each sample, the ratio N_{Co}/N_{Si} of the number proportion of cobalt atoms N_{Co} to the number proportion of silicon atoms N_{Si} in the first region was measured. The results are shown in Table 3 and Table 4.

### <Thermal Diffusivity>

The thermal diffusivity of the cubic boron nitride sintered body of Sample 1 to Sample 18 and Sample 1-1 to Sample 1-6 were measured by a laser flash method. The measurement conditions are as follows. In the laser flash method, “LFA467 Hyper Flash” (trade name) manufactured by NETZSCH Japan K.K. was used. The thermal diffusivity was calculated from a temperature history curve of the back side of the test slice when the front side of the test slice was irradiated with laser pulses (see JIS R1611:2010). The test slice had a square shape with a main surface of 10 mm on one side and a thickness of 1 to 2 mm, and the entire test slice was subjected to a blackbody treatment by graphite spraying. Each sample was measured three times, and the average values are shown in Table 3.

### <Measurement Conditions>

Laser voltage: 230 V
Pulse width: 0.3 ms
Measurement temperature: 25° C.

In Sample 1-2, the large number of voids were generated in the structure of the cubic boron nitride sintered body, and the thermal diffusivity could not be measured. In Sample 1-6, the crack were generated in the cubic boron nitride sintered body, and the thermal diffusivity could not be measured. The column “thermal diffusivity” in Table 3 shows “not measurable”.

### <Cutting Test 1>

A cutting tool (base material shape: SNGN090308, cutting edge treatment: T01225) was produced using the cubic boron nitride sintered body of Sample 1 to Sample 18 and Sample 1-1 to Sample 1-6, and Cutting test 1 was performed. The conditions of Cutting test 1 are as follows.

### <Cutting Conditions>

Cutting rate: 1,450 m/min.
Feed rate: 0.11 mm/rev.
Cut: 0.3 mm
Coolant: WET
Coolant liquid: emulsion % (diluted 20 times with water)
Cutter: RM3080R (manufactured by Sumitomo Electric Industries, Ltd.)
Cutting method: intermittent cutting
Lathes: NV5000 (manufactured by DMG MORI CO., LTD.)
Work material: Two FC250 perlite plates (cast iron) were simultaneously processed.

### <Evaluation Criteria>

The cutting edge was observed at every 0.5 km of the cutting distance, and amount of the chipping of the cutting edge was measured. The amount of the chipping of the cutting edge was defined as the retreating width due to wear from the position of the cutting edge ridge line before cutting. When the cutting edge was lost, the size of the loss was defined as the amount of the chipping of the cutting edge. The point of time when the amount of the chipping of the cutting edge became 0.1 mm or more was regarded as the life of the cutting tool, and the volume of the cast iron removed by cutting at that point of time (unit: cm³) was measured. The results of classification performed based on the criteria below are shown in Table 3. The larger the volume of the cast iron removed by cutting, the longer the life of the cutting tool.
A: 90 cm³ or more
B: 85 cm³ or more and less than 90 cm³
C: 70 cm³ or more and less than 85 cm³
D: 65 cm³ or more and less than 70 cm³
E: Less than 45 cm³

TABLE 3

| | Cubic boron nitride sintered body | | | | | | | | |
|---|---|---|---|---|---|---|---|---|---|
| | | | | | Circle | | | | |
| | | | | | equivalent | | | | |
| | cBN | binder | | | diameter d50 | | | Thermal | |
| Sample | grain | material | Co | Si | of cBN grain | Presence form | | diffusivity | Cutting |
| No. | vol % | vol % | atom % | atom % | μm | of Si and Co | N_{co}/Nₛᵢ | mm²/s | test 1 |
| 1 | 75 | 25 | 13.0 | 1.00 | 3 | solid solution | 13.0 | 36 | D |
| 2 | 75 | 25 | 1.5 | 7.00 | 3 | simple Si, | 0.2 | 38 | C |
| | | | | | | CoSi₂ | | | |
| 3 | 85 | 15 | 3.0 | 3.00 | 3 | CoSi | 1.0 | 45 | A |
| 4 | 90 | 10 | 5.0 | 0.75 | 3 | solid solution, | 12.0 | 48 | A |
| | | | | | | Co₂Si | | | |
| 5 | 95 | 5 | 0.5 | 0.10 | 3 | solid solution, | 5.0 | 47 | A |
| | | | | | | Co₂Si | | | |
| 6 | 75 | 25 | 3.0 | 6.60 | 3 | solid solution, | 0.5 | 35 | D |
| | | | | | | Co₂Si | | | |
| 1-1 | 70 | 30 | 7.5 | 6.60 | 3 | So₂Si, CoSi | 1.1 | 30 | E |
| 1-2 | 98 | 2 | 0.5 | 0.20 | 3 | solid solution, | 2.5 | not | E |
| | | | | | | Co₂Si | | measurable | |
| 1-3 | 90 | 10 | 0.3 | 1.00 | 3 | CoSi₂, | 0.3 | 47 | E |
| | | | | | | simple Si | | | |
| 1-4 | 75 | 25 | 14.0 | 0.40 | 3 | solid solution | 35.0 | 33 | E |
| 1-5 | 90 | 10 | 3.0 | 0.05 | 3 | solid solution | 60.0 | 40 | E |
| 1-6 | 75 | 25 | 0.5 | 8.50 | 3 | CoSi₂, | 0.1 | not | E |
| | | | | | | simple Si | | measurable | |
| 7 | 90 | 10 | 1.3 | 0.50 | 3 | solid solution, | 2.6 | 47 | A |
| | | | | | | Co₂Si | | | |
| 8 | 90 | 10 | 1.3 | 1.30 | 3 | CoSi | 1.0 | 46 | A |
| 9 | 90 | 10 | 0.5 | 1.00 | 3 | CoSi₂ | 0.5 | 47 | C |
| 10 | 75 | 25 | 0.5 | 7.00 | 3 | CoSi₂, | 0.1 | 38 | D |
| | | | | | | simple Si | | | |
| 11 | 75 | 25 | 12.0 | 0.10 | 3 | solid solution | 120.0 | 39 | C |
| 12 | 90 | 10 | 7.0 | 0.10 | 3 | solid solution | 70.0 | 46 | B |
| 13 | 90 | 10 | 2.0 | 0.10 | 3 | solid solution | 20.0 | 47 | A |
| 14 | 90 | 10 | 1.5 | 0.10 | 3 | solid solution | 15.0 | 48 | A |
| 15 | 75 | 25 | 13.0 | 0.10 | 3 | solid solution | 130.0 | 40 | D |
| 16 | 85 | 15 | 5.0 | 0.75 | 0.2 | solid solution, | 12.0 | 44 | B |
| | | | | | | Co₂Si | | | |
| 17 | 85 | 15 | 5.0 | 0.75 | 10 | solid solution, | 12.0 | 47 | B |
| | | | | | | Co₂Si | | | |
| 18 | 85 | 15 | 5.0 | 0.75 | 100 | solid solution, | 12.0 | 100 | B |
| | | | | | | Co₂Si | | | |

### <Consideration 1>

The cubic boron nitride sintered body and cutting tool of Sample 1 to Sample 18 correspond to the example. The cubic boron nitride sintered body and the cutting tool of Sample 1-1 to Sample 1-6 correspond to the comparative example. It was confirmed that the cutting tool of Sample 1 to Sample 18 had a longer tool life than the cutting tool of Sample 1-1 to Sample 1-6.

In the cubic boron nitride sintered body of Sample 1-2, a large number of voids were generated in the structure. This is because the content of the binder material is small.

The cubic boron nitride sintered body of Sample 1-3 sufficiently includes silicon, and thus the bonding force between cubic boron nitride grains is improved and the thermal diffusivity is improved. However, since the content of cobalt was low, the toughness of the cubic boron nitride sintered body was low, and the life of the cutting tool was reduced.

The cubic boron nitride sintered body of Sample 1-5 has a low thermal diffusivity, even though the content of the cubic boron nitride grain is as high as 90%. This suggests that the bonding force between cubic boron nitride grains is low, and thus the cutting performance of the cutting tool is reduced.

The cubic boron nitride sintered body of Sample 1-6 had cracks. This is because the content of silicon is too high.

### <Ratio IA/IB>

In the cubic boron nitride sintered body of Sample 19 to Sample 33, X-ray diffraction patterns were obtained by the method described in the first embodiment, and the ratio IA/IB of the peak integrated intensity IA of the (420) plane of W₂Co₂₁B to the peak integrated intensity IB of the (111) plane of cubic boron nitride was measured. The results are shown in Table 5.

### <First Interface Region>

In the cubic boron nitride sintered body of Sample 19 to Sample 33, the first interface region in which the distance from the first interface between ones of the cubic boron nitride grains adjacent to each other was within the 100 nm was identified by the method described in the first embodiment, and it was confirmed whether cobalt, silicon, and zirconium were present in the first interface region. Table 5 shows elements which is present in the first interface region. The symbol “-” indicates that none of cobalt, silicon, and zirconium is present.

### <Width D>

In the cubic boron nitride sintered body of Sample 19 to Sample 33, the second interface between the cubic boron nitride grain and the binder material adjacent to each other was identified by the method described in the first embodiment. The content of silicon was measured in the first direction from the second interface toward the inside of the cubic boron nitride grain, and the width D of the region where the silicon content was 0.1 atom % to 1.5 atom % was measured. The results are shown in Table 5.

### <Planar Defect in Co Structure>

In the cubic boron nitride sintered body of Sample 19 to Sample 33, BF-STEM images were obtained by the method described in the first embodiment, and the maximum value of the angle (indicated by 0° to 90°) formed by the streak-like pattern (corresponding to the planar defect) in the second region was measured. The results are shown in Table 5. When the angle is 90°, it is determined that the BF-STEM image of the cross section of the cubic boron nitride sintered body includes the second region in which cobalt is present, planar defects intersecting each other at 90° are present in the second region.

TABLE 4

| | Cubic boron nitride sintered body | | | | | | |
|---|---|---|---|---|---|---|---|
| | | | | | Circle | | |
| | | | | | equivalent | | |
| | CBN | binder | | | diameter d50 | | |
| Sample | grain | material | Co | Si | of cBN grain | Presence form | |
| No. | vol % | vol % | atom % | atom % | μm | of Si and Co | N_{co}/Nₛᵢ |
| 19 | 85 | 15 | 5.0 | 0.75 | 3 | solid solution, Co₂Si | 12.0 |
| 20 | 85 | 15 | 5.0 | 0.75 | 3 | solid solution, Co₂Si | 12.0 |
| 21 | 85 | 15 | 5.0 | 0.75 | 3 | solid solution, Co₂Si | 12.0 |
| 22 | 85 | 15 | 5.0 | 0.75 | 3 | solid solution, Co₂Si | 12.0 |
| 23 | 85 | 15 | 5.0 | 0.75 | 3 | solid solution, Co₂Si | 12.0 |
| 24 | 85 | 15 | 5.0 | 0.75 | 3 | solid solution, Co₂Si | 12.0 |
| 25 | 85 | 15 | 5.0 | 0.75 | 3 | solid solution, Co₂Si | 12.0 |
| 26 | 85 | 15 | 5.0 | 0.75 | 3 | solid solution, Co₂Si | 12.0 |
| 27 | 85 | 15 | 5.0 | 0.75 | 3 | solid solution, Co₂Si | 12.0 |
| 28 | 85 | 15 | 5.0 | 0.75 | 3 | solid solution, Co₂Si | 12.0 |
| 29 | 85 | 15 | 5.0 | 0.75 | 3 | solid solution, Co₂Si | 12.0 |
| 30 | 85 | 15 | 5.0 | 0.75 | 3 | solid solution, Co₂Si | 12.0 |
| 31 | 85 | 15 | 5.0 | 0.75 | 3 | solid solution, Co₂Si | 12.0 |
| 32 | 85 | 15 | 5.0 | 0.75 | 3 | solid solution, Co₂Si | 12.0 |
| 33 | 85 | 15 | 5.0 | 0.75 | 3 | solid solution, Co₂Si | 12.0 |

TABLE 5

| | Cubic boron nitride sintered body | | | |
|---|---|---|---|---|
| | | | Width D | |
| Sample No. | IA/IB | First interface region | nm | Planar defect |
| 19 | 2 | — | 0 | 70.6° |
| 20 | 0.02 | — | 0 | 70.6° |
| 21 | 0.05 | — | 0 | 70.6° |
| 22 | 0.1 | — | 0 | 70.6° |
| 23 | 0 | Ci, Si, Zr | 0 | 70.6° |
| 24 | 0 | Co, Si | 0 | 70.6° |
| 25 | 0 | Co, Zr | 0 | 70.6° |
| 26 | 0 | Co | 0 | 70.6° |
| 27 | 0 | Si | 0 | 70.6° |
| 28 | 0 | — | 20 | 70.6° |
| 29 | 0 | — | 500 | 70.6° |
| 30 | 0 | — | 1000 | 70.6° |
| 31 | 0 | — | 1050 | 70.6° |
| 32 | 0 | — | 0 | 90° |
| 33 | 0 | Ci, Si, Zr | 500 | 90° |

### <Cutting Test 2>

A cutting tool (base material shape: CNGA120408, cutting edge treatment: T01225) was produced using the cubic boron nitride sintered body of Sample 19 to Sample 33 and Sample 1-1 to Sample 1-6, and Cutting test 2 was performed. The conditions of Cutting test 2 are as follows.

### <Cutting Conditions>

Cutting rate: 250 mi/min.
Feed rate: 0.1 mm/rev.
Cut: 0.25 mm Coolant: WET
Cutting method: continuous cutting
Lathes: LB4000EX (manufactured by OKUMA Corporation)
Work material: sintered part (a quenching sintered metal D40 manufactured by Sumitomo Electric Industries, Ltd., hardness of the quenched cut portion: HRB75)

### <Evaluation Criteria>

The cutting edge was observed at every 0.5 km of the cutting distance, and the amount of wear of the cutting edge was measured. The cutting distance at the time when the amount of wear of the cutting edge reached 150 μm or more was measured. It is noted that, the above cutting distance is defined as the life of the cutting tool, and classification was performed based on the criteria below. The results are shown in Table 6. It can be evaluated that the longer the cutting distance is, the longer the life of the cutting tool is.
A: 5.0 km or more
B: 4.5 km or more and less than 5.0 km
C: 3.5 km or more and less than 4.5 km
D: 3.0 km or more and less than 3.5 km
E: 2.5 km or more and less than 3.0 km
F: Less than 2.5 km

TABLE 6

| Sample No. | Cutting test 2 |
|---|---|
| 19 | B |
| 20 | B |
| 21 | C |
| 22 | E |
| 23 | A |
| 24 | A |
| 25 | A |
| 26 | A |
| 27 | A |
| 28 | A |
| 29 | A |
| 30 | A |
| 31 | D |
| 32 | A |
| 33 | A |
| 1-1 | F |
| 1-2 | F |
| 1-3 | F |
| 1-4 | F |
| 1-5 | F |
| 1-6 | F |

### <Consideration 2>

The cubic boron nitride sintered body and cutting tool of Sample 19 to Sample 33 correspond to the example. The cubic boron nitride sintered body and the cutting tool of Sample 1-1 to Sample 1-6 correspond to the comparative example. It was confirmed that the cutting tool of Sample 19 to Sample 33 had a longer tool life than the cutting tool of Sample 1-1 to Sample 1-6.

When comparing Sample 19 to Sample 22, Sample 19 to Sample 21 in which IA/IB is 0.05 or less have a longer tool life than Sample 22 in which IA/IB is 0.1. This is because the smaller the amount of W₂Co₂₁B₆, which is a brittle phase, the higher the strength of the binder material, and the wear of the binder material during cutting and the chipping of the cubic boron nitride grains caused by the wear of the binder material are reduced.

When Sample 19 and Sample 23 to Sample 27 are compared, Sample 23 to Sample 27 in which at least one of Co, Si, or Zr is present in the first interface region have a longer tool life than Sample 19 in which these elements are not present in the first interface region. This is because, when at least one of Co, Si, or Zr is present in the first interface region, the bonding force between cubic boron nitride grains is improved, and the wear progression due to the chipping of the cubic boron nitride grains is reduced.

When comparing Sample 19 and Sample 28 to Sample 31, Sample 28 to Sample 30 having the width D of 20 to 1,000 nm have a longer tool life than Sample 19 having the width D of 0 nm and Sample 31 having a width B of 1,050 nm. This is because the cubic boron nitride grain including silicon in an amount such that the width D is 20 to 1,000 nm has a large bonding force to the binder material and the cubic boron nitride grain not including silicon, and thus the wear progression due to the chipping of the cubic boron nitride grain is reduced.

From the comparison between Sample 19 and Sample 32 and the comparison between Sample 23 and Sample 33, it was confirmed that the tool life of the sample in which the planar defects intersecting each other at 90° were present in the second region was longer than that of the sample in which the planar defects were not present. This is because the second region in which the planar defect (90°) of the {110} plane is present has a higher strength than the second region in which the twin defect is present, and thus the wear of binder material during cutting and the chipping of the cubic boron nitride grain caused by the wear of binder material are reduced.

Although the embodiments and examples of the present disclosure have been described above, it is originally intended that the configurations of the above embodiments and examples may be appropriately combined or variously modified. The embodiments and examples disclosed herein are illustrative in all respects and should not be construed as limiting. The scope of the present invention is defined by the appended claims rather than the foregoing embodiments and examples, and is intended to include all modifications within the scope and meaning equivalent to the appended claims.

### REFERENCE SIGNS LIST

1 rake face,
2 flank face,
3 cutting edge ridge line portion,
4 streak-like pattern,
5 second region

1. A cubic boron nitride sintered body comprising 75 vol % to 95 vol % of cubic boron nitride grains and 5 vol % to 25 vol % of a binder material,
wherein the cubic boron nitride sintered body has a silicon content of 0.10 atom % to 7 atom %, and
the cubic boron nitride sintered body has a cobalt content of 0.5 atom % to 13 atom %.

2. The cubic boron nitride sintered body according to claim 1,
wherein the binder material includes silicon and cobalt, and
the binder material includes one or both of a solid solution of the silicon and the cobalt and a compound having the silicon and the cobalt.

3. The cubic boron nitride sintered body according to claim 1,
wherein a first image obtained by elemental analysis of the cubic boron nitride sintered body using an energy dispersive X-ray spectrometer attached to a scanning transmission electron microscope includes a first region where the silicon is present, and
a ratio N_{Co}/N_{Si} of a number proportion of cobalt atoms N_{Co} to a number proportion of silicon atoms N_{Si} in the first region is 0.5 to 120.

4. The cubic boron nitride sintered body according to claim 3, wherein the N_{Co}/N_{Si} is 1 to 75.

5. The cubic boron nitride sintered body according to claim 4, wherein the N_{Co}/N_{Si} is 1 to 25.

6. The cubic boron nitride sintered body according to claim 1,
wherein the binder material includes tungsten, and
in an X-ray diffraction pattern of the cubic boron nitride sintered body, a ratio IA/IB of a peak integrated intensity IA of a (420) plane of W₂Co₂₁B₆ to a peak integrated intensity IB of a (111) plane of cubic boron nitride is 0.05 or less.

7. The cubic boron nitride sintered body according to claim 1,
wherein the cubic boron nitride sintered body has a first interface region where a distance from a first interface between ones of the cubic boron nitride grains adjacent to each other is within 100 nm, and
at least a part of the first interface region includes one or both of cobalt and silicon.

8. The cubic boron nitride sintered body according to claim 1,
wherein the binder material includes zirconium,
the cubic boron nitride sintered body has a first interface region where a distance from a first interface between ones of the cubic boron nitride grains adjacent to each other is within 100 nm, and
at least a part of the first interface region includes zirconium.

9. The cubic boron nitride sintered body according to claim 1,
wherein the cubic boron nitride sintered body has a second interface between one of the cubic boron nitride grains and the binder material adjacent to each other, and
when the silicon content is measured in a first direction from the second interface toward an inside of the cubic boron nitride grain,
a width D of a region where the silicon content is 0.1 atom % to 1.5 atom % is 20 nm to 1,000 nm.

10. The cubic boron nitride sintered body according to claim 1,
wherein a BF-STEM image of a cross section of the cubic boron nitride sintered body includes a second region where cobalt is present, and
planar defects intersecting each other at 90° are present in the second region.

11. A cutting tool comprising the cubic boron nitride sintered body according to claim 1.
